(19) United States
(12) Patent Application Publication
(10) Pub. No.: US 2021/0282064 A1
(43) Pub. Date: Sep. 9, 2021

(54) HIGH-SPEED MOBILITY COMMUNICATION SYSTEMS AND METHODS

(71) Applicant: Intel Corporation, Santa Clara, CA (US)

(72) Inventors: Jun Wang, Beijing (CN); Jingqian Wang, Beijing (CN); Donghui Guo, Beijing (CN); Weijie Sun, Beijing (CN); Jiapeng Li, Beijing (CN); Pengbo Du, Beijing (CN); Yan Lu, Beijing (CN); Xiongjun Huang, Beijing (CN); Yucheng Dai, Beijing (CN); Xiaolei Tang, Beijing (CN); Yubo Zhou, Beijing (CN)

(21) Appl. No.: 16/500,302

(22) PCT Filed: Jun. 30, 2017
(86) PCT No.: PCT/CN2017/091094

§ 371 Date: Oct. 2, 2019

(51) Int. Cl. H04W 36/32; H04W 36/00

(52) U.S. Cl. CPC H04W 36/32; H04W 36/0022

(57) ABSTRACT

In wireless communication systems and methods for high-speed mobility deployments, a mobility status of a communication device can be determined. For example, the speed at which the communication device is traveling can be determined (e.g. such as communication devices traveling on a high-speed transportation (HST) system). HST networks can be prioritized based on the determined mobility status of the communication device when performing a fallback communication and/or when returning from the fallback communication.

### BACKGROUND

### Field

Aspects described herein generally relate to wireless communication systems and methods for high-speed mobility deployments, including wireless communication systems and methods for wireless communications with communication devices aboard and/or implemented in high-speed transportation systems (e.g., high-speed trains).

### Related Art

Wireless communication networks can be deployed for particular environments, including to service transportation systems (e.g., high-speed train systems) having transportation routes through and/or along the deployed network. In conventional systems, a communication device using the transportation system may begin to use a neighboring network along the transportation route instead of returning to or reconnecting with the deployed network configured to service the communication devices of users of the transportation system, thereby suffering from, for example (but not limited to), increased handover frequency, reduced voice quality, increased dropped communications, increased radio link failure, and/or reduced throughput.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates a wireless communication system according to one or more exemplary aspects of the present disclosure.

FIG. 2 illustrates a communication device according to exemplary aspects of the present disclosure.

FIGS. 3A-3B illustrate a flowchart of a method of performing wireless communication by a wireless communication device according to an exemplary aspect of the present disclosure.

FIGS. 4A-4B illustrate a flowchart of a method of performing wireless communication by a wireless communication device according to an exemplary aspect of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

The present disclosure is directed to wireless communication systems and methods for high-speed mobility deployments, including wireless communication systems and methods for wireless communications while in a high-mobility state, such as when the user of the communication device is traveling on a high-speed transportation systems (e.g., high-speed trains). While this disclosure is described with respect to deployments associated high-speed train systems, it is understood that the disclosure is not limited in this respect. The aspects may be applicable to other (non-high speed) transportation systems and/or other high-speed transportation systems, as well as non-transportation deployments. Further, aspects are applicable to deployments that include multiple communication networks and selection of the network can be based on one or more characteristics of the communication device and/or supporting base stations (and/or other network components).

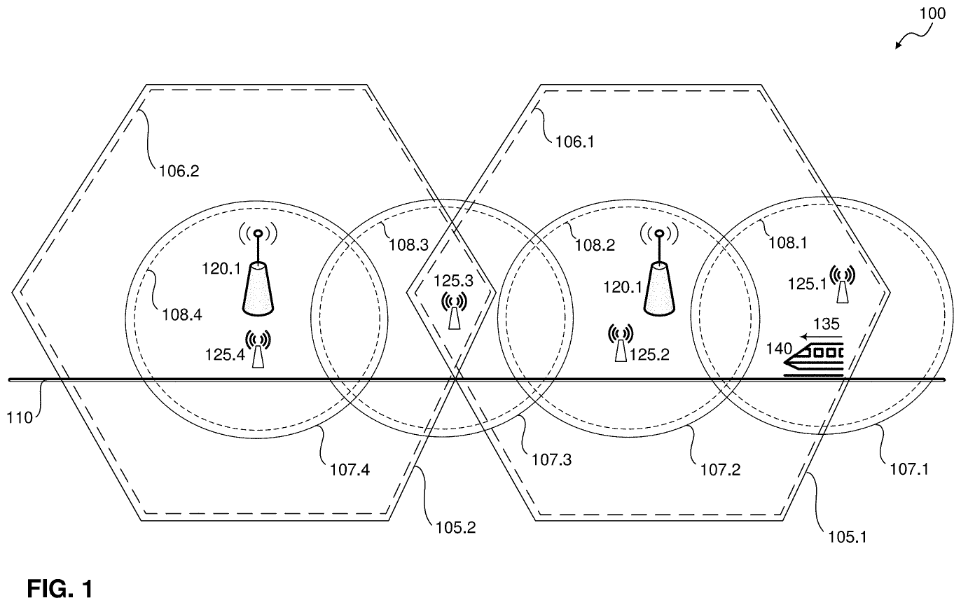

FIG. 1 illustrates a wireless communication system 100 according to exemplary aspects of the present disclosure. The wireless communication system 100 includes one or more radio access networks (RANs) supported by one or more backhaul networks (not shown). The backhaul network can include one or more well-known communication components-such as one or more network switches, one or more network gateways, and/or one or more servers. The network can include one or more devices and/or components configured to exchange data with one or more other devices and/or components via one or more wired and/or wireless communications protocols. In exemplary aspects, the base stations 120 and/or 125 communicate with one or more service providers and/or one or more other base stations 120 and/or 125 via the backhaul network. In an exemplary aspect, the backhaul network is an internet protocol (IP) backhaul network, such as the Internet. In an exemplary aspect, the backhaul network includes one or more components of an evolved packet core.

In an exemplary aspect, the communication system 100 includes one or more base stations 120 supporting a first communication network (cells 105, 106), one or more other base stations 125 supporting a second communication network (cells 107, 108), and one or more wireless communication devices 140. The communication system 100 is described with respect to, for example, a high-speed transportation system, in particular a high-speed train system that includes a train 135 traveling along a path 110 (e.g. train track) in the direction of the arrow (i.e., in the left direction relative to the drawing). As illustrated in FIG. 1, the train 135 is also referenced by number 140, which indicates that one or more communication devices 140 are onboard (and/or implemented within) the train 135. The base station(s) 120 and/or 125 may be, for example, an eNodeB, a small cell, a femto cell, a pico cell, a micro cell, a road side unit, or other infrastructure devices capable of wireless communications. The number of base stations 120, base stations 125, and/or wireless communication devices 140 are not limited to the exemplary quantities illustrated in FIG. 1, and the wireless communication system 100 can include any number of the various components as would be understood by one of ordinary skill in the relevant art(s).

In an exemplary aspect, the first communication network supported by base stations 120 is designated as a high-speed transportation (HST) network while the second communication network supported by base stations 125 is a general (i.e., non-HST) network. The first and the second communication networks can be configured to support the same wireless communication technologies (e.g., LTE, GSM), or different communication technologies.

In an exemplary aspect, the first communication network is configured to support communications devices 140 traveling at a high-rate of speed (e.g., a communication device 140 with high mobility), such as those communication devices 140 aboard (and/or implemented within) the high-speed train 135. For example, one or more wireless characteristics, such as the modulation and coding scheme, handoff/handover configurations, frequencies, gain, and/or one or more other characteristics and/or parameters as would be understood by those skilled in the art, can be configured for communications with communication devices 140 having high mobility. Additionally or alternatively, the base station 120 (including one or more components of the base station 120) can be configured for communications with communication devices 140 having high mobility, including, for example, antenna gain, antenna type and/or configuration, the degree at which adjacent cells overlap, and/or one or more other characteristics and/or parameters as would be understood by those skilled in the art.

In an exemplary aspect, the cells 105 and/or 106 of base stations 120 have a larger service area than the cells 107 and/or 108 of the base stations 125. In this example, the larger cells 105, 106 of the base stations 120 reduce the frequency of handoff/handover operations as the communication device(s) 140 move along the path 110 through the cells 105, 106.

In an exemplary aspect, the base station 120 and/or the base station 125 are configured to support two or more networks of different communication technologies. For example, the base station 120 can support a first network represented by cell 105 and a second network represented by cell 106. Similarly, base station 125 can support a first network represented by cell 107 and a second network represented by cell 108. In an exemplary aspect, the first and second networks are a main network and a fallback network, respectively.

In an exemplary aspect, the main networks (e.g., cells 105 and 107) support a higher generation technology (e.g., fourth generation (4G) or fifth generation (5G)) than the communication technology (e.g., third generation (3G) or second generation (2G)) of the fallback networks (e.g., cells 106 and 108)).

In an exemplary aspect, the main networks (e.g., cells 105 and 107) are packet-based networks (e.g., LTE or other 3GPP communication technology) and the fallback networks (e.g., cells 106 and 108) includes one or more circuit-switched networks (e.g., GSM). The main and fallback networks are not limited to these example technologies, and the main and/or fallback networks can support one or more other technologies as would be understood by one of ordinary skill in the relevant arts.

In an exemplary aspect, the communication device 140 can be configured to perform Circuit Switched FallBack (CSFB) communication using the main and fallback networks corresponding to base station 120 and/or base station 125. For example, the communication device 140 can be configured to wirelessly communicate (e.g., a data communication) with the base station 120 using LTE via cell 105, and initiate and perform a CSFB voice call with the base station 120 using GSM via cell 106.

In an exemplary aspect, because the communication device 140 is traveling at a high rate of speed, the communication device 140 can prefer to utilize the HST communication network of base stations 120. However, in some cases, the communication device 140 may connect with the non-HST fallback network of the base station 125 when performing the CSFB because of one or more characteristics of the base station 125 (and corresponding cell 108). For example, the cell 108 may have a higher signal strength than the signal strength of the cell 106, which may cause the communication device 140 to select the non-HST cell 108 instead of the HST cell 106 even though the communication device 140 is traveling at a high rate of speed.

In an exemplary aspect, the communication device 140 is configured to detect or otherwise determine a movement characteristic of the communication device 140, such as the speed, velocity, acceleration, position, orientation, and/or other movement characteristic as would be understood by one of ordinary skill in the art. In an exemplary aspect, the communication device 140 can include a movement sensor (e.g., speed, velocity, acceleration sensor) that is configured to detect the movement characteristic of the communication device 140. The communication device 140 can determine a mobility status of the communication device 140 based on the detected movement characteristic(s). Based on the determined mobility status and/or the movement characteristic(s), the communication device 140 can be configured to prioritize the HST communication networks of the base station 120 over the non-HST networks of the base station 125. In this example, the communication device 140 can prioritize the HST fallback network of cell 106 when performing a fallback communication (e.g. CSFB voice call, text message, etc.) and/or prioritize the HST main network of cell 105 when returning from the fallback communication. In one or more aspects, the HST networks and non-HST networks can be differentiated based on system information. For example, the base stations 120 associated with the HST networks can include system information, such as a system information block (SIB), a SIB2, and/or SIB3, etc. that identifies the associated network/cells as HST networks/cells. The system information (e.g. SIB2) can include a flag “HighSpeedFlag” that has a value (e.g. “true”) indicating that the network/cell is a HST network/cell. On the other hand, the system information of the non-HST networks/cells can have a HighSpeedFlag set to a value (e.g. “false”) indicating that the network/cell is a non-HST network/cell. In these examples, the corresponding base stations 120, 125 can provide the system information (including the HighSpeedFlag) to the communication device 140. Based on the system information, the communication device 140 can determine whether the base station 120,125 and its associated networks/cells are HST or non-HST networks/cells.

The communication device(s) 140, the base station(s) 120, and/or the base station(s) 125 can include a transceiver configured to transmit and/or receive wireless communications via one or more wireless technologies within the communication environment 100. In operation, the communication devices 140 can be configured to communicate with the base stations 120 and/or 125 and/or with one or more other devices 140.

In an exemplary aspect, the communication device(s) 140 are configured to wireless communicate with one or more base stations 120 and/or 125 using one or more radio communication technologies and/or standards including, for example, the Global System for Mobile Communications (GSM) radio communication technology; one or more Third Generation Partnership Project (3GPP) radio communication technologies, such as Long Term Evolution (LTE) and/or Long Term Evolution Advanced (LTE Advanced); and/or one or more 5th Generation (5G) wireless communication protocols. In one or more aspects, the communication device 140 can be configured to communicate with one or more base stations 120 and/or 125 using, for example, Wi-Fi. In an exemplary aspect, the communication device(s) 140 are configured to communication with one or more other communication devices 140 using one or more device-to-device communication technologies (e.g., Bluetooth).

In an exemplary aspect, communications device 140 is a mobile communication device that is onboard the train 135. Alternatively, the communication 140 is implemented as an integrated communication device of the train 135. Non-limiting examples of the communication devices 140 include: a mobile communication device-such as a laptop computer, a tablet computer, a mobile telephone or smartphone, a “phablet,” a personal digital assistant (PDA), and mobile media player; and a wearable computing device-such as a computerized wrist watch or “smart” watch, and computerized eyeglasses; Internet of Things (IoT) devices; and/or other wireless devices configured for wireless communication via one or more wireless technologies; vehicles (e.g., trains, automobiles, nautical vessels, aircraft, motorcycles, bicycles, etc.) or drones configured for wireless communication, such as transportation systems that include one or more wireless communication receivers and/or wireless communication receivers transmitters, and/or automotive/aeronautical/maritime/train in-dash computer terminals.

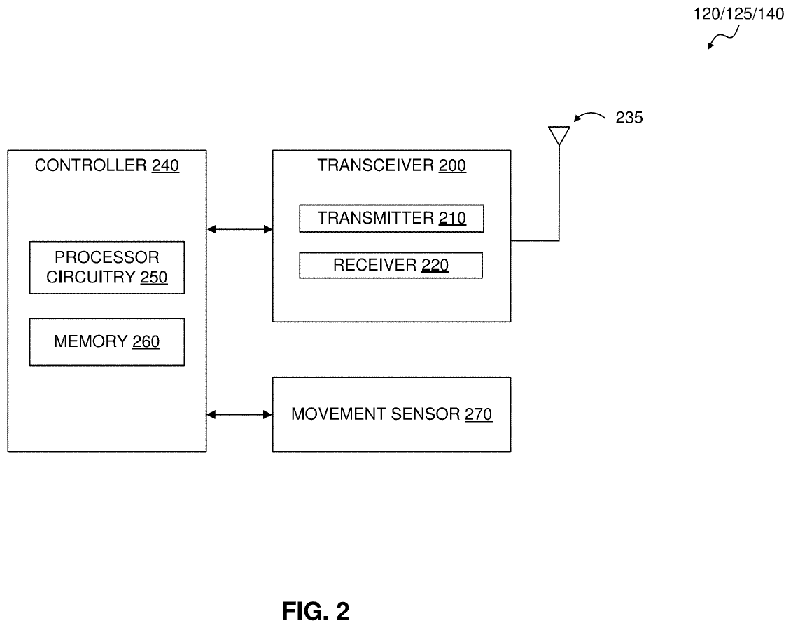

FIG. 2 illustrates exemplary aspects of a base station 120, base station 125, and/or communication device 140. In one or more exemplary aspects, the base station 120, base station 125, and/or the communication device 140 can include a controller 240 communicatively coupled to one or more transceivers 200. In an exemplary aspect, the communication device 140 can additionally include a movement sensor 270 communicatively coupled to the controller 240.

The transceiver(s) 200 can be configured to transmit and/or receive wireless communications via one or more wireless technologies, such as one or more cellular technologies (e.g., LTE, GSM, one or more 5G technologies), one or more non-cellular technologies (e.g., WiFi, Bluetooth), and/or one or more other contention and/or non-contention based protocols. The transceiver 200 can include processor circuitry that is configured for transmitting and/or receiving wireless communications conforming to one or more wireless technologies. For example, the transceiver 200 can include a transmitter 210 and a receiver 220 configured for transmitting and receiving wireless communications, respectively, via one or more antennas 235.

The transceiver 200 can determine radio characteristics such as, for example, wireless channel information, the radio access technologies (RATs) being used, parameters and/or characteristics of the RATs, the modulation and coding scheme, and/or one or more other characteristics and/or parameters as would be understood by those skilled in the art. The radio characteristics can then be provided to the controller 240 to be used for one or more functions of the controller 240.

In exemplary aspects, the transceiver 200 can include (but is not limited to) a digital signal processer (DSP), modulator and/or demodulator, a digital-to-analog converter (DAC) and/or an analog-to-digital converter (ADC), an encoder/decoder (e.g., encoders/decoders having convolution, tail-biting convolution, turbo, Viterbi, and/or Low Density Parity Check (LDPC) encoder/decoder functionality), a frequency converter (including mixers, local oscillators, and filters), Fast-Fourier Transform (FFT), precoder, and/or constellation mapper/de-mapper that can be utilized in transmitting and/or receiving of wireless communications. In one or more aspects, the transmitter 210 and/or receiver 220 can include one or more of these components. Further, those skilled in the relevant art(s) will recognize that antenna 235 may include an integer array of antennas, and that the antennas may be capable of both transmitting and receiving wireless communication signals.

The movement sensor 270 can include processor circuitry that is configured to detect or otherwise determine one or more movement characteristics of the communication device 140. The movement characteristics can include (but are not limited to), for example, speed, velocity, acceleration, position, orientation, and/or other movement characteristic as would be understood by one of ordinary skill in the art. The movement sensor 270 can be referred to by the characteristic(s) it is configured to detect (e.g., speed sensor, etc.).

The controller 240 can include processor circuitry 250 that is configured to control the overall operation of the device (e.g., communication device 140, base station 120, base station 125), such as the operation of the transceiver 200 and/or the movement sensor 270 (in aspects of the communication device 140). The processor circuitry 250 can be configured to, for example, control the transmitting and/or receiving of wireless communications via the transceiver 200 and/or perform (and/or control the transceiver 220 to perform) one or more baseband processing functions (e.g., radio frequency (RF) to baseband conversion, media access control (MAC), encoding/decoding, modulation/demodulation, data symbol mapping; error correction, etc.). The processor circuitry 250 can be configured to run one or more applications and/or operating systems; power management (e.g., battery control and monitoring); display settings; volume control; and/or user interactions via one or more user interfaces (e.g., keyboard, touchscreen display, microphone, speaker, etc.).

In an exemplary aspect, the controller 240 (e.g. the processor circuitry 250) can be configured to determine the mobility status of the communication device 140 based on the movement characteristic(s) detected by the movement sensor 270. In an exemplary aspect, the controller 240 can additionally or alternatively determine one or more movement characteristics of the communication device 140 based on one or more signal characteristics (e.g., received signal strength indicator (RSSI)) of signals received from the transceiver 200.

In an exemplary aspect, the controller 240 can be configured to control the communication device 140 to determine communication network information, such as network frequencies, one or more Evolved Absolute Radio Frequency Channel Numbers (EARFCNs), and/or system information (e.g. system information including HighSpeedFlag identifying network/cell as HST or non-HST network/cell; and/or cell bar qualify (CBQ) flag identifying the network/cell as a low-priority network/cell) of one or more networks and/or of one or more cells of the network(s). For example, the communication device 140 can determine the communication network information associated with one or more networks (e.g. networks of base stations 120, 125) currently serving the communication device 140 and/or scan for available networks and determine communication network information based on the networks discovered by the scanning operation(s). In an exemplary aspect, the communication device 140 receives system information associated with the networks/cells from the corresponding base station 120, 125.

The controller 240 can be configured to perform one or more network selection operations to select one or more communication networks to be used by the communication device 120 to wireless communicate based on the determined mobility status and/or the movement characteristic(s). For example, the controller 240 can be configured to prioritize one or more communication networks over one or more other communication networks based on the determined mobility status and/or the movement characteristic(s). In an exemplary aspect, the controller 240 is configured to prioritize one or more HST communication networks of the base station 120 over one or more non-HST networks of the base station 125. In this example, the controller 240 can prioritize the HST fallback network of cell 106 when performing a fallback communication (e.g. CSFB voice call, text message, etc.) and/or prioritize the HST main network of cell 105 when returning from the fallback communication. In an exemplary aspect, the communication device 120 can differentiate between HST and non-HST networks/cells based on the system information (e.g. system information including HighSpeedFlag identifying network/cell as HST or non-HST network/cell).

In an exemplary aspect, the communication device 140 is configured to receive release information (e.g. release message) from the main network currently serving the communication device 140 to facilitate the fallback communication (e.g. CSFB voice call, text message, etc.). In an exemplary aspect, the release information does not include redirection information for use by the communication device 140 to assist in the selection of the fallback network for the fallback communication. In an exemplary aspect, the communication device 140 can ignore system information corresponding to the HST communication networks of base stations 120 when redirection information is omitted from the release information. In this example, the communication device 140 can select an appropriate fallback HST communication network even if the system information associated with the fallback HST communication network indicates that the fallback HST communication network is a low priority network.

In an exemplary aspect, the HST communication network of base stations 120 may include system information (e.g., System Information Block (SIB)) that indicates that the HST communication network of base stations 120 is a low priority network. In an exemplary aspect, the system information includes a cell bar qualify (CBQ) flag whose value (e.g. 1) is set to indicate that the HST communication network of base stations 120 is a low priority network. The SIB can be, for example, a SIB2, a SIB3, etc.

In an exemplary operation, the low priority indication can be used to prevent communication devices that have a low-speed mobility (e.g. non-HST devices) from utilizing the HST communication networks of base stations 120. That is, the low-priority indication can be used to limit the use of the HST communication networks of base stations 120 to devices having a high-speed mobility (e.g., communication devices 140 traveling at a high rate of speed). In aspects where the communication device 140 receives release information without redirection information, the communication device 140 can use the system information (e.g., CBQ flag) to determine which fallback communication network to select and establish communication with. For example, the communication device 140 can be configured to scan for available fallback networks and select a fallback network to utilize based on the system information and/or one or more wireless characteristics (e.g. signal strength) of the various networks discovered by the scan.

In an exemplary aspect, to increase the likelihood that the communication device 140 establishes the fallback communication on a HST fallback network (e.g., cell 106 of base station 120), the controller 240 can be configured to prioritize scanned fallback network cells based on one or more signal characteristics (e.g., signal strength) while ignoring system information associated with the fallback networks. For example, the controller 240 can be configured to generate a fallback cell list of scanned network cells. The fallback cells list can include a list of the fallback communication networks and/or of one or more cells of the fallback communication networks. The cell list can be a look-up table in one or more aspects.

In an exemplary aspect, the controller 240 can be configured to adjust the order of the cells within the fallback cell list based on the signal characteristic(s) (e.g. signal strength). For example, the controller 240 can sort the cells (e.g. in descending order) based on the signal strength without consideration of the priority information provided in the system information of the HST communication networks of base stations 120. In this example, the communication device 140 will increase the likelihood of connecting with one or more fallback HST communication networks of base stations 120 (e.g. cell 106) for the fallback communication.

In an exemplary aspect, the omission of the system information (and corresponding priority information) in the determination of the fallback communication network can be based on the mobility status of the communication device 140.

For example, if the communication device 140 (e.g., controller 240) determines that the communication device 140 is traveling at a high-rate of speed (e.g. has a high-speed mobility status), the controller 240 can ignore the system information (and corresponding priority information) in the determination of the fallback communication network. In this example, the controller 240 can reorder the cells/networks of the fallback cell list based on the signal characteristic(s).

If the communication device 140 (e.g., controller 240) determines that the communication device 140 is not traveling at a high-rate of speed (e.g. has a low-speed mobility status), the controller 240 can consider the system information and/or the signal characteristic(s) in the determination of the fallback communication network. In this example, the communication device 140 can reorder the networks of the fallback cell list based on the signal characteristic(s) and/or the system information. For example, because the HST communication networks of base station 120 can include a low-priority indication in the system information, the communication device 140 can deprioritize the HST communication networks when selecting an appropriate fallback communication network to establish the fallback communication.

In aspects where the HST main network of cell 105 is prioritized when returning from the fallback communication, the controller 240 can be configured to generate one or more cell lists based on the communication network information. For example, the controller 240 can generate a cell list based on the communication network information. In an exemplary aspect, the cells list includes a list of the communication networks and/or of one or more cells of the communication networks. The cell list can be a look-up table in one or more aspects. In an exemplary aspect, the cell list is a sequence of frequencies, such as Evolved Absolute Radio Frequency Channel Numbers (EARFCNs). In an exemplary aspect, the cell list is a Found EARFCN Sequence (FES) of EARFCNs found during a scan of available networks. Table 1 shows an example FES.

TABLE 1
FES sorted based on signal characteristic(s) (e.g. signal strength)

| | EARFCN | A | B | C | D | E | F | G |
|---|---|---|---|---|---|---|---|---|
| FES | Cell Type | Non- | HST | Non- | HST | HST | Non- | Non- |
| | | HST | | HST | | | HST | HST |
| | Signal | 90 | 87 | 80 | 75 | 72 | 70 | 65 |
| | Strength | | | | | | | |

In an exemplary aspect, the communication device 140 (e.g. controller 240) can be configured to adjust a cell order of cells within the cell list based on one or more signal characteristics (e.g. signal strength), communication network information and/or characteristics, cell information and/or characteristics, and/or other information as would be understood by one of ordinary skill in the art.

In an exemplary aspect, the controller 240 can sort cells A-G based on, for example, signal strength as shown in Table 1. In this example, Table 1 includes HST and non-HST network cells, with the non-HST cells shown in blue and the HST cells shown in green. The cells have been sorted (e.g. descending order) based on the signal strength without consideration of the cell type.

In an exemplary aspect, the controller 240 can sort cells A-G based on the signal characteristics (e.g. signal strength) and the cell type, and based on the mobility status of the communication device 140. For example, when the communication device 140 is traveling at a high-rate of speed (e.g. has a high-speed mobility status), the controller 240 can determine communication network information (e.g., EARFCNs) associated with one or more networks (e.g. networks of base stations 120, 125) currently serving the communication device 140 and/or scan for available networks and determine communication network information based on the networks discovered by the scanning operation(s). The controller 240 can generate a cell list (e.g. FES) of the serving and/or discovered networks that includes the cell type and one or more signal characteristics (e.g. signal strength) of the corresponding EARFCNs of the networks. The controller 240 can adjust (e.g., reorder) the cell order of the cells of the cell list based on signal characteristic (e.g., signal strength) to generate an adjusted or sorted cell list (e.g. adjusted FES; Table 1). The controller 240 can then reorder the cells of the adjusted cell list to prioritize the HST cells within the adjusted cell list to generate a prioritized cell list (e.g. prioritized FES). As example of the prioritized cell list (e.g. prioritized FES) is shown below in Table 2.

TABLE 2
Prioritized FES

| | EARFCN | B | D | E | A | C | F | G |
|---|---|---|---|---|---|---|---|---|
| FES | Cell Type | HST | HST | HST | Non- | Non- | Non- | Non- |
| | | | | | HST | HST | HST | HST |
| | Signal | 87 | 75 | 72 | 90 | 80 | 70 | 65 |
| | Strength | | | | | | | |

The communication controller 240 can further include a memory 260 that stores data and/or instructions, where when the instructions are executed by the processor circuitry 250, controls the processor circuitry 250 to perform the functions described herein. In one or more exemplary aspects, the memory 260 stores one or more determined mobility statuses; one or more movement characteristic(s); communication network information, such as network frequencies, one or more Evolved Absolute Radio Frequency Channel Numbers (EARFCNs), and/or system information of one or more networks and/or of one or more cells of the network(s); one or more cell lists (e.g. FES); one or more adjusted cell lists (e.g. adjusted FES); one or more prioritized cell lists (e.g. prioritized FES); and/or other information as would be understood by one of ordinary skill in the relevant arts.

The memory 260 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 260 can be non-removable, removable, or a combination of both.

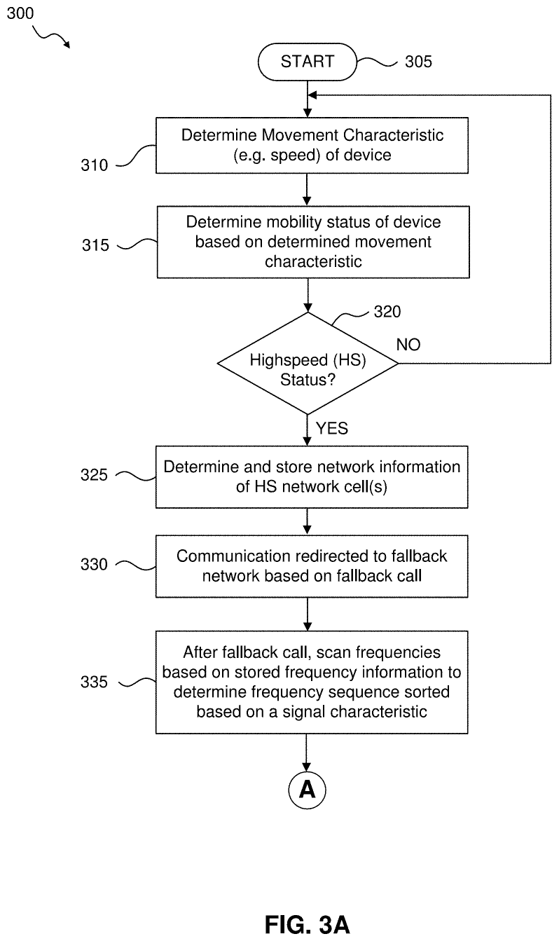

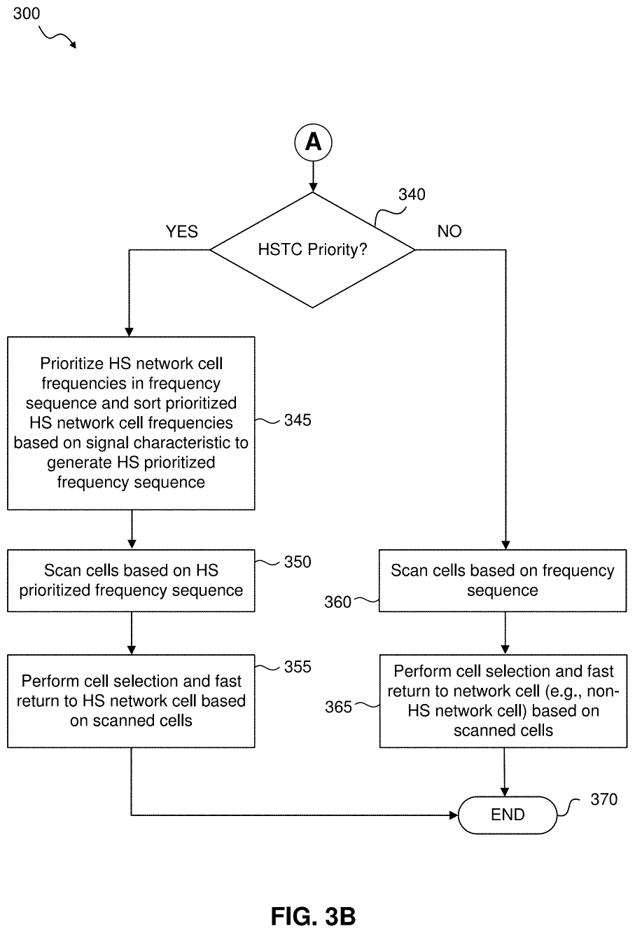

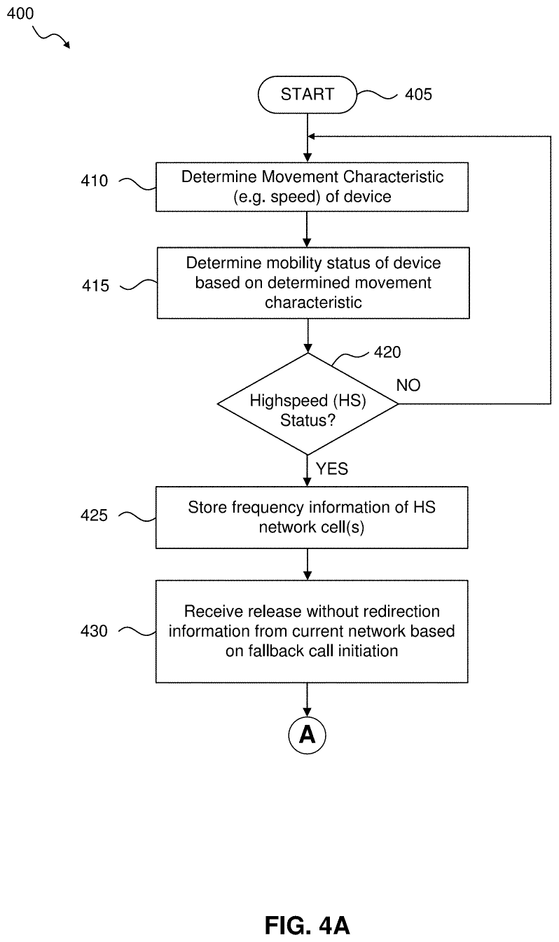

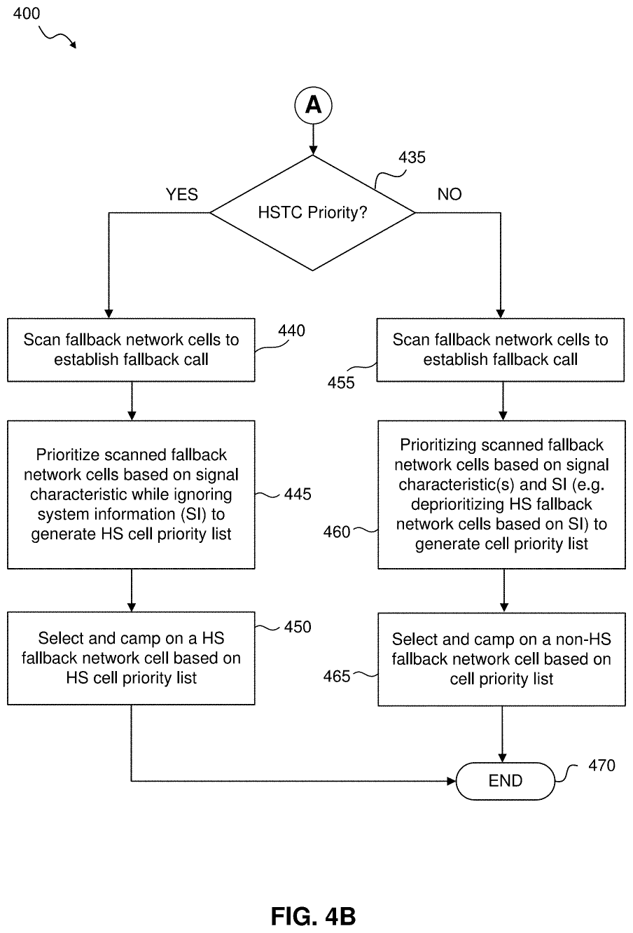

Exemplary aspects of the network selection operations of the controller 240 are described in further detail below with reference to FIGS. 3A-4B.

FIGS. 3A-3B illustrates a flowchart 300 of a method of performing wireless communication by a wireless communication device according to an exemplary aspect of the present disclosure. The flowchart is described with continued reference to FIGS. 1-2. The operations of the method are not limited to the order described below, and the various operations may be performed in a different order. Further, two or more operations of the method may be performed simultaneously with each other.

The method of flowchart 300 begins at operation 305 and transitions to operation 310, where one or more movement characteristics are determined. In an exemplary aspect, the movement sensor 270 determines one or more movement characteristics (e.g. speed, velocity, acceleration, position, orientation) of the communication device 140. For example, the movement sensor 270 can detect the speed of the communication device 140.

After operation 310, the flowchart 300 transitions to operation 315, where the mobility status of the communication device 140 is determined. In an exemplary aspect, the mobility status is determined based on one or more determined movement characteristics of the communication device 140. In an exemplary aspect, the controller 240 determines the mobility status of the communication device 140 based on the movement characteristic(s) from the movement sensor 270. For example, the controller 240 can determine if the communication device 140 is traveling at a high-rate of speed (e.g. has a high-speed mobility status) or is not moving at a high-rate of speed.

In an exemplary aspect, the controller 240 can be configured to compare the determined movement characteristic with a threshold value, to determine the status of the communication device 140. For example, the controller 240 can be configured to compare the determined speed at which the communication device is traveling to a speed threshold value to determine if the mobility status of the communication device 140 is a high-speed mobility status. In an exemplary aspect, the speed threshold value is, for example, 200 kilometers per hour (km/h), but is not limited thereto. In this example, the controller 240 can compare the detected speed of the communication device 140 from the movement sensor 270 to the speed threshold (e.g. 200 km/h).

If the speed of the communication device 140 is greater than the speed threshold (e.g. 200 km/h) (YES at operation 320), the controller 240 can determine that the communication device 140 has a high-speed mobility status. Based on the high-speed mobility status, the communication device 140 can connect to and establish communications with one or more HST communication networks of base stations 120. In this example, the communication device 140 can identify the communication network as a HST communication network based on system information (e.g. system information including HighSpeedFlag identifying network/cell as HST or non-HST network/cell) received from the network/cell. If the speed of the communication device 140 is less than or equal to the speed threshold (e.g. 200 km/h) (NO at operation 320), the controller 240 can determine that the communication device 140 does not have a high-speed mobility status. When the communication device 140 does not have a high-speed mobility status (e.g. is traveling at a slower speed), the communication device 140 can connect to and establish communications with one or more non-HST communication networks of base stations 125. In this case, (NO at operation 320), the flowchart 300 returns to operation 310.

If the communication device 140 has a high-speed mobility status (YES at operation 320), the flowchart 300 transitions to operation 325, where communication network information of one or more communication networks is determined. In an exemplary aspect, the controller 240 can control the communication device 140 to determine communication network information of the HST communication network(s) of base stations 120. For example, the communication device 140 can determine the communication network information of the network(s) currently serving the communication device 140 and/or the communication device 140 can scan for available networks and determine communication network information based on the networks discovered by the scanning operation(s). The communication network information can include (but not limited to) network frequencies, one or more Evolved Absolute Radio Frequency Channel Numbers (EARFCNs), and/or system information (e.g. system information including HighSpeedFlag identifying network/cell as HST or non-HST network/cell; and/or cell bar qualify (CBQ) flag identifying the network/cell as a low-priority network/cell) of one or more networks and/or of one or more cells of the network(s).

In an exemplary aspect, the communication device 140 is configured to identify whether the serving and/or scanned communication networks are HST communication networks (e.g. based on the system information), and can determine the communication network information of one or more HST communication networks based on the identification of the communication network as a HST communication network.

In an exemplary aspect, the determined communication network information can be stored in the memory 260 of the communication device 140. In an exemplary aspect, the communication device 140 can determine (and store) frequency information of one or more of the HST communication networks of base stations 120 (e.g. one or more Evolved Absolute Radio Frequency Channel Numbers (EARFCNs) of the HST communication network(s)). In an exemplary aspect, communication device 140 can determine (and store) one or more cell lists, including one or more FES based on determined EARFCNs.

After operation 325, the flowchart 300 transitions to operation 330, where communication is redirected to a fallback communication network in response to a fallback communication (e.g. CSFB voice call, text message, etc.) being initiated. In an exemplary aspect, the communication device 140 (e.g. controller 240) can be configured to initiate a fallback communication and one or more communications are redirected from a main network (e.g. HST main network of cell 105) to a fallback network (e.g. HST fallback network of cell 106).

After operation 330, the flowchart 300 transitions to operation 335, where, in response to the fallback call being terminated, the controller 240 can be configured to control the communication device 140 to scan for available networks (e.g. available main networks) to return to from the fallback communication on fallback network. In an exemplary aspect, the communication device 140 can scan for available networks based on one or more cell lists, such as one or more adjusted and/or prioritized cell lists (e.g. FES, adjusted FES, prioritized FES).

In an exemplary aspect, the communication device 140 can be configured to enable/disable a high-speed transportation cell (HSTC) prioritization mode. In an exemplary aspect, the controller 240 can selectively enable the HSTC periodization mode. The selection can be based on user input, one or more characteristics of the communication device 140 (e.g., battery status, one or more operating parameters of the communication device 140, etc.), communication network settings, and/or one or more other parameters as would be understood by one of ordinary skill in the art.

If the HSTC prioritization mode is enabled (or the communication device 140 is otherwise configured for HSTC prioritization) (YES at operation 340), the flowchart 300 transitions to operation 345. If the HSTC prioritization mode is disabled (or the communication device 140 is otherwise not configured for HSTC prioritization) (NO at operation 340), the flowchart 300 transitions to operation 360.

At operation 345, one or more cells lists are adjusted to reorder the cells of adjusted cell list to prioritize the HST cells. For example, the order of the cells within the FES can be adjusted (e.g. cells can be reorder) based on one or more signal characteristics (e.g. signal strength) and cell type (e.g. HST cells vs. non-HST cells) to prioritize the HST cells over the non-HST in the FES to generate a prioritized FES. In an exemplary aspect, the controller 240 can sort cells based on the signal characteristics (e.g. signal strength) and the cell type. For example, when the communication device 140 is traveling at a high-rate of speed (e.g. has a high-speed mobility status), the controller 240 can determine communication network information (e.g., EARFCNs) associated with one or more networks (e.g. networks of base stations 120, 125) currently serving the communication device 140 and/or scan for available networks and determine communication network information based on the networks discovered by the scanning operation(s). The controller 240 can adjust (e.g., reorder) the cell order of the cells of the cell list (FES) based on signal characteristic (e.g., signal strength) to generate an adjusted or sorted cell list (e.g. adjusted FES). The controller 240 can then reorder the cells of adjusted cell list to prioritize the HST cells within the adjusted cell list to generate a prioritized cell list (e.g. prioritized FES).

After operation 345, the flowchart 300 transitions to operation 350, available communication networks are scanned. For example, the controller 240 can scan for available networks based on the prioritized cell list (e.g. prioritized FES) to determine a main network (e.g. HST main network of cell 105) to return to from the fallback network (e.g. HST fallback network of cell 106) supporting the terminated fallback communication.

After operation 350, the flowchart 300 transitions to operation 355, cell selection can be performed to return the communication device 140 to a main network (e.g. HST main network of cell 105). In an exemplary aspect, the controller 240 can select a network (e.g. HST main network of cell 105) from the prioritized cell list (e.g. prioritized FES) that was detected by the network scan to fast return to the selected HST network from the fallback network.

After operation 355, the flowchart 300 transitions to operation 370, where the flowchart 300 ends. The method of flowchart 300 can be repeated for subsequent fallback communications.

At operation 360, available communication networks are scanned. For example, the controller 240 can scan for available networks based on the adjusted cell list (e.g. adjusted FES adjusted based on the signal characteristic) to determine a main network to return to from the fallback network (e.g. HST fallback network of cell 106) supporting the terminated fallback communication.

After operation 360, the flowchart 300 transitions to operation 365, cell selection can be performed to return the communication device 140 to a main network. In an exemplary aspect, the controller 240 can select a network from the adjusted cell list (e.g. adjusted FES) that was detected by the network scan to fast return to the selected main network from the fallback network. In this example, the communication device 140 can return to a non-HST or a HST main network based on the signal characteristic. That is, priority is not given to the HST main networks over the non-HST main networks, and the communication device 140 will select the main network having, for example, the highest signal strength.

After operation 365, the flowchart 300 transitions to operation 370, where the flowchart 300 ends. The method of flowchart 300 can be repeated for subsequent fallback communications.

FIGS. 4A-4B illustrates a flowchart 400 of a method of performing wireless communication by a wireless communication device according to an exemplary aspect of the present disclosure. The flowchart is described with continued reference to FIGS. 1-3B. The operations of the method are not limited to the order described below, and the various operations may be performed in a different order. Further, two or more operations of the method may be performed simultaneously with each other.

The method of flowchart 400 begins at operation 405 and transitions to operation 410, where one or more movement characteristics are determined. In an exemplary aspect, the movement sensor 270 determines one or more movement characteristics (e.g. speed, velocity, acceleration, position, orientation) of the communication device 140. For example, the movement sensor 270 can detect the speed of the communication device 140.

After operation 410, the flowchart 400 transitions to operation 415, where the mobility status of the communication device 440 is determined. In an exemplary aspect, the mobility status is determined based on one or more determined movement characteristics of the communication device 140. In an exemplary aspect, the controller 240 determines the mobility status of the communication device 140 based on the movement characteristic(s) from the movement sensor 270. For example, the controller 240 can determine if the communication device 140 is traveling at a high-rate of speed (e.g. has a high-speed mobility status) or is not moving at a high-rate of speed.

In an exemplary aspect, the controller 240 can be configured to compare the determined movement characteristic with a threshold value to determine the status of the communication device 140. For example, the controller 240 can be configured to compare the determined speed at which the communication device 140 is traveling to a speed threshold value to determine if the mobility status of the communication device 140 is a high-speed mobility status. In an exemplary aspect, the speed threshold value is, for example, 200 kilometers per hour (km/h), but is not limited thereto. In this example, the controller 240 can compare the detected speed of the communication device 140 from the movement sensor 270 to the speed threshold (e.g. 200 km/h).

If the speed of the communication device 140 is greater than the speed threshold (e.g. 200 km/h) (YES at operation 420), the controller 240 can determine that the communication device 140 has a high-speed mobility status. Based on the high-speed mobility status, the communication device 140 can connect to and establish communications with one or more HST communication networks of base stations 120. If the speed of the communication device 140 is less than or equal to the speed threshold (e.g. 200 km/h) (NO at operation 420), the controller 240 can determine that the communication device 140 does not have a high-speed mobility status. When the communication device 140 does not have a high-speed mobility status (e.g. is traveling at a slower speed), the communication device 140 can connect to and establish communications with one or more non-HST communication networks of base stations 125. In this case, (NO at operation 420), the flowchart 300 returns to operation 310.

If the communication device 140 has a high-speed mobility status (YES at operation 420), the flowchart 300 transitions to operation 425, where communication network information of one or more communication networks is determined. In an exemplary aspect, the controller 240 can control the communication device 140 to determine communication network information of the HST communication network(s) of base stations 120. For example, the communication device 140 can determine the communication network information of the network(s) currently serving the communication device 140 and/or the communication device 140 can scan for available networks and determine communication network information based on the networks discovered by the scanning operation(s).

In an exemplary aspect, the determined communication network information can be stored in the memory 260 of the communication device 140. In an exemplary aspect, the communication device 140 can determine (and store) frequency information of one or more of the HST communication networks of base stations 120 (e.g. one or more Evolved Absolute Radio Frequency Channel Numbers (EARFCNs) of the HST communication network(s)). In an exemplary aspect, communication device 140 can determine (and store) one or more cell lists, including one or more FES based on determined EARFCNs.

After operation 425, the flowchart 400 transitions to operation 430, where release information (e.g. release message) from the main network currently serving the communication device 140 to facilitate the fallback communication (e.g. CSFB voice call, text message, etc.). In an exemplary aspect, the release information does not include redirection information for use by the communication device 140 to assist in the selection of the fallback network for the fallback communication.

In an exemplary aspect, the communication device 140 can be configured to enable/disable a high-speed transportation cell (HSTC) prioritization mode for fallback communications. In an exemplary aspect, the controller 240 can selectively enable the HSTC periodization mode. The selection can be based on user input, one or more characteristics of the communication device 140 (e.g., battery status, one or more operating parameters of the communication device 140, etc.), communication network settings, and/or one or more other parameters as would be understood by one of ordinary skill in the art.

If the HSTC prioritization mode is enabled (or the communication device 140 is otherwise configured for HSTC prioritization) (YES at operation 435), the flowchart 400 transitions to operation 440. If the HSTC prioritization mode is disabled (or the communication device 140 is otherwise not configured for HSTC prioritization) (NO at operation 435), the flowchart transitions to operation 455.

At operation 440, available fallback networks are determined (e.g. scanned) to establish a fallback communication. For example, the communication device 140 (e.g. controller 240) can be configured to scan for available fallback networks to establish a fallback communication. The controller 240 can be configured to generate a fallback cell list of scanned network cells. The cell lists can include the communication network information (e.g., network frequencies, EARFCNs, etc.), one or more signal characteristics of the corresponding scanned networks, system information of the corresponding scanned networks, and/or other information as would be understood by one of ordinary skill in the relevant arts.

After operation 440, the flowchart 400 transitions to operation 445, where scanned fallback network cells are prioritized based on one or more signal characteristic (e.g. signal strength) while ignoring system information of the corresponding fallback communication networks. For example, the controller 240 can reorder the cells of the fallback cell list based one or more signal characteristic (e.g. signal strength) while ignoring system information to generate HST fallback priority cell list. In this example, the HST communication networks of base stations 120 will not be deprioritized based on, for example, a CBQ flag that indicates that the corresponding HST communication network is a low priority network.

After operation 445, the flowchart 400 transitions to operation 450, where a fallback communication network is selected from the HST fallback priority cell list to establish the fallback communication. The controller 240 can be configured to control the communication device 140 to camp on the selected network for the fallback communication. In this example, the likelihood of selecting a HST fallback communication network for the fallback communication is increased by not deprioritizing the HST fallback communication networks based on the system information. That is, the communication device 140 can select an appropriate HST fallback communication network even if the system information associated with the HST fallback communication network indicates that the network is a low priority network.

After operation 450, the flowchart 400 transitions to operation 470, where the flowchart 400 ends. The method of flowchart 400 can be repeated for subsequent fallback communications.

At operation 455, available fallback networks are determined (e.g. scanned) to establish a fallback communication. For example, the communication device 140 (e.g. controller 240) can be configured to scan for available fallback networks to establish a fallback communication. The controller 240 can be configured to generate a fallback cell list of scanned network cells. The cell lists can include the communication network information (e.g., network frequencies, EARFCNs, etc.), one or more signal characteristics of the corresponding scanned networks, system information of the corresponding scanned networks, and/or other information as would be understood by one of ordinary skill in the relevant arts.

After operation 455, the flowchart 400 transitions to operation 460, where scanned fallback network cells are prioritized based on one or more signal characteristic (e.g. signal strength) and system information of the corresponding fallback communication networks. For example, the controller 240 can reorder the cells of the fallback cell list based one or more signal characteristic (e.g. signal strength) and system information to generate a fallback cell list. In this example, the HST communication networks of base stations 120 may be deprioritized if their system information so indicates (e.g. a CBQ flag that indicates that the corresponding HST communication network is a low priority network).

After operation 460, the flowchart 400 transitions to operation 465, where a fallback communication network is selected from the fallback cell list to establish the fallback communication. The controller 240 can be configured to control the communication device 140 to camp on the selected network for the fallback communication.

After operation 465, the flowchart 400 transitions to operation 470, where the flowchart 400 ends. The method of flowchart 400 can be repeated for subsequent fallback communications.

Again, while aspects of the present disclosure are described with respect to high-speed train deployments, it is understood that the disclosure is not limited in this respect, and the aspects are applicable to other (non-high speed) transportation systems and/or other high-speed transportation systems, as well as non-transportation deployments. Further, aspects are applicable to deployments that include multiple communication networks and selection of the network can be based on one or more characteristics of the communication device and/or supporting base stations (and/or other network components).

### Examples

Example 1 is a communication device adapted for communicating in a communication system, the communication device comprising: a transceiver configured to communicate with first and second communication networks; and a controller coupled to the transceiver and configured to: determine a mobility status of the communication device; adjust a cell order of cells of the first and the second communication networks, based on a signal characteristic of the cells of the first and the second networks and the mobility status of the communication device, to generate a prioritized cell list; and select, based on the prioritized cell list, a cell corresponding to the first communication network to establish a communication using the selected cell of the first communication network.

In Example 2, the subject matter of Example 1, further comprising a movement sensor configured to detect a movement characteristic of the communication device, wherein the controller is configured to determine the mobility status based on the movement characteristic.

In Example 3, the subject matter of Example 2, wherein the movement characteristic is: a speed at which the communication device is traveling; and/or a change in the speed at which the communication device is traveling.

In Example 4, the subject matter of Example 1, wherein the adjusting the cell order comprises: adjusting the cell order of the cells of the first and the second communication networks, based on the signal characteristic of the cells of the first and the second networks, to generate a cell list; and prioritizing the cells of the first communication network within the cell list, based on the mobility status of the communication device, to generate the prioritized cell list.

In Example 5, the subject matter of any of Examples 1-4, wherein the established communication is established from a return of a Circuit Switched FallBack (CSFB) communication.

In Example 6, the subject matter of Example 1, wherein the first and the second communication networks each comprise a circuit-switched network and a packet-based network.

In Example 7, the subject matter of Example 6, wherein the circuit-switched network is a Global System for Mobile Communications (GSM) network and the packet-based network uses a communication technology defined by the 3rd Generation Partnership Project (3GPP).

In Example 8, the subject matter of Example 6, wherein the circuit-switched network uses a second generation (2G) communication technology and the packet-based network uses a fourth generation (4G) communication technology.

In Example 9, the subject matter of Example 6, wherein the circuit-switched network uses a lower generation communication technology than a communication technology generation of the packet-based network.

In Example 10, the subject matter of any of Examples 6-9, wherein the packet-based network is a Long Term Evolution (LTE) network.

In Example 11, the subject matter of any of Examples 6-9, wherein the established communication is established on the packet-based network of the first communication network from a return of a Circuit Switched FallBack (CSFB) communication on the circuit-switched network of the first communication network.

In Example 12, the subject matter of any of Examples 1-11, wherein the first communication network is associated with a high-speed transportation system and is prioritized over the second communication network for communication devices using the high-speed transportation system, the prioritization being based on the mobility status of the communication device.

Example 13 is a communication device adapted for communicating in a communication system, the communication device comprising: a transceiver configured to communicate with first and second communication networks, the first and the second communication networks each including a main network and fallback network; and a controller coupled to the transceiver and configured to: determine a mobility status of the communication device; receive release information from the first communication network using the transceiver, the release information lacking redirection information; prioritize cells of the fallback network of the first communication network over cells of the second communication network within a cell list, based on the mobility status and a signal characteristic of the cells of the fallback network of the first communication network while ignoring system information of the cells of the fallback network of the first communication network, to generate a prioritized cell list; and select, based on the prioritized cell list, a cell of the fallback network of the first communication network to establish a communication on the selected cell.

In Example 14, the subject matter of Example 13, further comprising a movement sensor configured to detect a movement characteristic of the communication device, wherein the controller is configured to determine the mobility status based on the movement characteristic.

In Example 15, the subject matter of Example 14, wherein the movement characteristic is: a speed at which the communication device is traveling; and/or a change in the speed at which the communication device is traveling.

In Example 16, the subject matter of any of Examples 13-15, wherein the established communication is a Circuit Switched FallBack (CSFB) communication.

In Example 17, the subject matter of Example 13, wherein the main networks of the first and second communication networks are packet-based networks and the fallback networks of the first and second communication networks include circuit-switched networks.

In Example 18, the subject matter of Example 17, wherein the circuit-switched network is a Global System for Mobile Communications (GSM) network and the packet-based network uses a communication technology defined by the 3rd Generation Partnership Project (3GPP).

In Example 19, the subject matter of Example 17, wherein at least one of the circuit-switched networks uses a second generation (2G) communication technology and at least one of the packet-based networks uses a fourth generation (4G) communication technology.

In Example 20, the subject matter of Example 17, wherein at least one of the circuit-switched networks uses a lower generation communication technology than a communication technology generation of at least one of the packet-based networks.

In Example 21, the subject matter of any of Examples 17-20, wherein at least one of the packet-based networks is a Long Term Evolution (LTE) network.

In Example 22, the subject matter of any of Examples 13-21, wherein the first communication network is associated with a high-speed transportation system and is prioritized over the second communication network for communication devices using the high-speed transportation system, the prioritization being based on the mobility status of the communication device.

Example 23 is a method for performing wireless communication by a communication device in a communication system including first and second communication networks, the first and the second communication networks each including a main network and fallback network, the method comprising: determining a mobility status of the communication device;

receiving release information from the first communication network in response to a request to initiate a fallback communication, the release information lacking redirection information; prioritizing cells of the fallback network of the first communication network over cells of the second communication network, based on the mobility status and a signal characteristic of the cells of the fallback network of the first communication network while ignoring system information of the cells of the fallback network of the first communication network, to generate a prioritized cell list; and selecting, based on the prioritized cell list, a cell of the fallback network of the first communication network to establish the fallback communication on the selected cell.

In Example 24, the subject matter of Example 23, further comprising: determining a cell list including cells of the first and the second communication networks; adjusting a cell order of the cells of the first and the second communication networks, based on the signal characteristic of the cells of the first and the second networks, to generate an adjusted cell list; prioritizing the cells of the first communication network within the adjusted cell list, based on the mobility status of the communication device, to generate a second prioritized cell list; and selecting, based on the second prioritized cell list, a cell of the main network of the first communication network to return to from the fallback communication on the fallback network of the first communication network and to establish a communication using the selected cell of the main network of the first communication network.

In Example 25, the subject matter of Example 24, wherein: the main network is a packet-based network and the fallback network includes a circuit-switched network; and the fallback communication is a Circuit Switched FallBack (CSFB) communication.

Example 26 is an apparatus comprising means to perform the method as described in any of Examples 23-25.

Example 27 is a communication device comprising a processor and a memory that stores program instructions, the processor being configured to execute the program instructions to perform the method as described in any of Examples 23-25.

Example 28 is a non-transitory computer-readable storage medium with program instructions stored thereon, when executed, causes a processor to perform the method of any of Examples 23-25.

Example 29 is an apparatus substantially as shown and described.

Example 30 is a method substantially as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Any of the radio links may operate according to any one or more of the following radio communication technologies and/or standards including, but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee (e.g., IEEE 802.15.4), Bluetooth®, Worldwide Interoperability for Microwave Access (WiMAX), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-Everything (V2X) and Vehicle-to-Infrastructure (V2I), Infrastructure-to-Vehicle (I2V), Vehicle-to-Device (V2D) communication technologies, 3GPP cellular V2X, IEEE 802.11p based, DSRC (Dedicated Short Range Communications) communication systems such as Intelligent-Transport-Systems and others, etc.

The concepts can also be used in the context of any spectrum management scheme including dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies). Applicable spectrum bands include IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc.). Note that some bands are limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Furthermore, a hierarchical application of the scheme is possible, for example, by introducing a hierarchical prioritization of usage for different types of wireless devices (e.g., low/medium/high priority, etc.), based on a prioritized access to the spectrum, for example, with highest priority to tier-1 wireless devices, followed by tier-2, then tier-3, etc. wireless devices, etc.

The concepts can also be applied to different Single Carrier or OFDM varieties, such as CP-OFDM, SC-FDMA, SC-OFDM, filter bank-based multicarrier (FBMC), OFDMA, etc., and in particular 3GPP NR (New Radio) by allocating the OFDM carrier data bit vectors to the corresponding symbol resources.

1-25. (canceled)

26. A communication device adapted for communicating in a communication system, the communication device comprising:
a transceiver configured to communicate with first and second communication networks; and
a controller coupled to the transceiver and configured to:
determine a mobility status of the communication device;
adjust a cell order of cells of the first and the second communication networks, based on a signal characteristic of the cells of the first and the second networks and the mobility status of the communication device, to generate a prioritized cell list; and
select, based on the prioritized cell list, a cell corresponding to the first communication network to establish a communication using the selected cell of the first communication network.

27. The communication device of claim 26, further comprising a movement sensor configured to detect a movement characteristic of the communication device, wherein the controller is configured to determine the mobility status based on the movement characteristic.

28. The communication device of claim 27, wherein the movement characteristic is:
a speed at which the communication device is traveling; and/or
a change in the speed at which the communication device is traveling.

29. The communication device of claim 26, wherein the adjusting the cell order comprises:
adjusting the cell order of the cells of the first and the second communication networks, based on the signal characteristic of the cells of the first and the second networks, to generate a cell list; and
prioritizing the cells of the first communication network within the cell list, based on the mobility status of the communication device, to generate the prioritized cell list.

30. The communication device of claim 26 wherein the established communication is established from a return of a Circuit Switched FallBack (CSFB) communication.

31. The communication device of claim 26, wherein the first and the second communication networks each comprise a circuit-switched network and a packet-based network.

32. The communication device of claim 31, wherein the circuit-switched network is a Global System for Mobile Communications (GSM) network and the packet-based network uses a communication technology defined by the 3rd Generation Partnership Project (3GPP).

33. The communication device of claim 31, wherein the circuit-switched network uses a second generation (2G) communication technology and the packet-based network uses a fourth generation (4G) communication technology.

34. The communication device of claim 31, wherein the circuit-switched network uses a lower generation communication technology than a communication technology generation of the packet-based network.

35. The communication device of claim 31, wherein the packet-based network is a Long Term Evolution (LTE) network.

36. The communication device of claim 31, wherein the established communication is established on the packet-based network of the first communication network from a return of a Circuit Switched FallBack (CSFB) communication on the circuit-switched network of the first communication network.

37. The communication device of claim 26, wherein the first communication network is associated with a high-speed transportation system and is prioritized over the second communication network for communication devices using the high-speed transportation system, the prioritization being based on the mobility status of the communication device.

38. A communication device adapted for communicating in a communication system, the communication device comprising:
a transceiver configured to communicate with first and second communication networks, the first and the second communication networks each including a main network and fallback network; and
a controller coupled to the transceiver and configured to:
determine a mobility status of the communication device;
receive release information from the first communication network using the transceiver, the release information lacking redirection information;
prioritize cells of the fallback network of the first communication network over cells of the second communication network within a cell list, based on the mobility status and a signal characteristic of the cells of the fallback network of the first communication network while ignoring system information of the cells of the fallback network of the first communication network, to generate a prioritized cell list; and
select, based on the prioritized cell list, a cell of the fallback network of the first communication network to establish a communication on the selected cell.

39. The communication device of claim 38, further comprising a movement sensor configured to detect a movement characteristic of the communication device, wherein the controller is configured to determine the mobility status based on the movement characteristic.

40. The communication device of claim 39, wherein the movement characteristic is:
a speed at which the communication device is traveling; and/or
a change in the speed at which the communication device is traveling.

41. The communication device of claim 38, wherein the established communication is a Circuit Switched FallBack (CSFB) communication.

42. The communication device of claim 38, wherein the main networks of the first and second communication networks are packet-based networks and the fallback networks of the first and second communication networks include circuit-switched networks.

43. The communication device of claim 42, wherein the circuit-switched network is a Global System for Mobile Communications (GSM) network and the packet-based network uses a communication technology defined by the 3rd Generation Partnership Project (3GPP).

44. The communication device of claim 42, wherein at least one of the circuit-switched networks uses a second generation (2G) communication technology and at least one of the packet-based networks uses a fourth generation (4G) communication technology.

45. The communication device of claim 42, wherein at least one of the circuit-switched networks uses a lower generation communication technology than a communication technology generation of at least one of the packet-based networks.

46. The communication device of claim 42, wherein at least one of the packet-based networks is a Long Term Evolution (LTE) network.

47. The communication device of claim 38, wherein the first communication network is associated with a high-speed transportation system and is prioritized over the second communication network for communication devices using the high-speed transportation system, the prioritization being based on the mobility status of the communication device.

48. A method for performing wireless communication by a communication device in a communication system including first and second communication networks, the first and the second communication networks each including a main network and fallback network, the method comprising:
determining a mobility status of the communication device;
receiving release information from the first communication network in response to a request to initiate a fallback communication, the release information lacking redirection information;
prioritizing cells of the fallback network of the first communication network over cells of the second communication network, based on the mobility status and a signal characteristic of the cells of the fallback network of the first communication network while ignoring system information of the cells of the fallback network of the first communication network, to generate a prioritized cell list; and
selecting, based on the prioritized cell list, a cell of the fallback network of the first communication network to establish the fallback communication on the selected cell.

49. The method of claim 48, further comprising:
determining a cell list including cells of the first and the second communication networks;
adjusting a cell order of the cells of the first and the second communication networks, based on the signal characteristic of the cells of the first and the second networks, to generate an adjusted cell list;
prioritizing the cells of the first communication network within the adjusted cell list, based on the mobility status of the communication device, to generate a second prioritized cell list; and
selecting, based on the second prioritized cell list, a cell of the main network of the first communication network to return to from the fallback communication on the fallback network of the first communication network and to establish a communication using the selected cell of the main network of the first communication network.

50. The method of claim 49, wherein:
the main network is a packet-based network and the fallback network includes a circuit-switched network; and
the fallback communication is a Circuit Switched FallBack (CSFB) communication.
